(19) United States
(12) Patent Application Publication
(10) Pub. No.: US 2025/0161905 A1
(43) Pub. Date: May 22, 2025

(54) METHOD OF PREPARING CARBON NANOSHEETS FOR CARBON DIOXIDE ADSORPTION

(71) Applicant: KING FAHD UNIVERSITY OF PETROLEUM AND MINERALS, Dhahran (SA)

(72) Inventors: Mohd Yusuf KHAN, Dhahran (SA); Aamir HANIF, Dhahran (SA); Md. Abdul AZIZ, Dhahran (SA)

(73) Assignee: KING FAHD UNIVERSITY OF PETROLEUM AND MINERALS, Dhahran (SA)

(21) Appl. No.: 18/515,856

(22) Filed: Nov. 21, 2023

(51) Int. Cl. B01J 20/20; B01D 53/04; B01J 20/30

(52) U.S. Cl. CPC B01J 20/205; B01D 53/04; B01J 20/3078; B01D 2253/102; B01D 2253/306; B01D 2253/308; B01D 2253/311; B01J 2220/485

(57) ABSTRACT

Aspects of the present disclosure are directed to a method of preparing carbon nanosheets, including mixing dried and pulverized Corchorus olitorius sticks with an activation agent in a mass ratio range of 1:1 to 1:10 to form a mixture. Further, the method includes heating the mixture in an inert atmosphere in the range of 500° C. to 700° C. for 2 hours to 8 hours to form the carbon nanosheets. The heating of the mixture includes ramping at a rate of 10° C./min in a range of 50° C. to 700° C. The carbon nanosheets have an average pore diameter of 0.1 nm to 1.0 nm and a carbon dioxide adsorption capacity of 0.5 mmol/g to 3.5 mmol/g and the carbon nanosheets form a porous foam with perforated carbon nanosheet cell walls.

### STATEMENT REGARDING PRIOR DISCLOSURE BY THE INVENTORS

Aspects of the present disclosure are described in Khan et al., “CO₂ Adsorption on Pore-Engineered Carbons Derived from Jute Sticks” published in Volume 18, Issue 17, Chemistry: An Asian Journal, which is incorporated herein by reference in its entirety.

### STATEMENT OF ACKNOWLEDGEMENT

Support provided by the Interdisciplinary Research Center for Hydrogen and Energy Storage (IRC-HES), King Fahd University of Petroleum and Minerals, Saudi Arabia, through Project INHE2103 is gratefully acknowledged.

### BACKGROUND

### Technical Field

The present disclosure is directed to carbon nanosheets, more particularly to jute stick-derived carbon nanosheets for efficiently adsorbing carbon dioxide (CO₂).

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

Presently, global warming is one of the pressing concerns of the 21^{st} century, with worldwide efforts to control it. Anthropogenic carbon dioxide (CO₂) emissions from fossil fuels have long been recognized as a contributing factor in the exponential rise of CO₂ levels in the atmosphere. Anthropogenic emissions of CO₂ disrupt the natural balance of CO₂ between the different sources and sinks on Earth. The current levels of CO₂ are above 420 ppm (Mauna Loa Observatory, Hawaii, Mar. 5, 2023), which is a 51% increase from pre-industrial revolution levels of around 278 ppm. This increase has led to drastic impacts on the climate, including rising sea levels, receding glaciers, and food insecurity. It is imperative to slow and reverse the growing trend of CO₂ build-up in the atmosphere. Strategies such as using energy-efficient industrial processes and technologies, replacing conventional energy sources with renewable ones, and capturing CO₂ through sequestration have been proposed as short- to long-term solutions to combat this issue; however, total severance from fossil fuels is impractical. Carbon capture and sequestration are more immediate and effective responses for continued and sustainable development.

Several techniques have been assessed for capturing CO₂, including chemical absorption, membrane separation, and solid adsorbent-based adsorption. Of these techniques, solid adsorbent-based adsorption is considered a clean and cost-effective option, with the effectiveness relying on the design of the adsorbent. Various materials, including alkali and alkaline metal oxides, functionalized silicas, layered double hydroxides, zeolites, and activated carbons, have been considered for CO₂ capture. The preferred adsorbents possess high CO₂ adsorption capacity and selectivity, rapid kinetics, easy regeneration, and can be produced in bulk at a reasonable cost.

Recently, biomass-derived carbons have been proposed as a more environmentally friendly and cost-effective alternative to synthetic adsorbents. These carbons can be made from readily available raw materials such as agricultural, animal, and food waste. They also have porous structures with surface functionalities that can be easily modified using various physical and chemical activation methods. Enhancing the micropores with a diameter of less than 1 nm is particularly effective in increasing CO₂ capture capacity. These narrow pores are close to the kinetic diameter of CO₂ and can interact with the gas through overlapping adsorption forces and potential fields from neighboring pore walls. Post-synthesis activation processes for biomass-derived carbons obtain a high degree of microporosity. These processes involve using CO₂ or steam as activating agents at temperatures between 500-900° C. to enhance micropore development and increase CO₂ adsorption capacities. These methods are often time-consuming and energy-intensive due to the two-step process of carbon formation followed by activation. Additionally, the resulting porosity can vary depending on factors such as temperature, flow rate, and even the instrumentation used for synthesis. Therefore, a more straightforward and effective strategy is desired.

Despite numerous advances in the field, there still exists a need to develop a method that overcomes the limitations of the art. Accordingly, an object of the present disclosure is to develop an efficient method for adsorption-based carbon capture from biomass-derived material in a clean and energy-efficient way to overcome the limitations of the art.

### SUMMARY

In an exemplary embodiment, a method of preparing carbon nanosheets is disclosed. The method includes mixing dried and pulverized Corchorus olitorius sticks with an activation agent in a mass ratio range of 1:1 to 1:10 to form a mixture. The activation agent is a carbonate salt. and the method further includes heating the mixture in an inert atmosphere in the range of 500° C. to 700° C. for 2 hours to 8 hours to form the carbon nanosheets. The heating of the mixture includes ramping at a rate of 10° C./min in a range of 50° C. to 700° C., and the carbon nanosheets have an average pore diameter of 0.1 nanometers (nm) to 1.0 nm with a carbon dioxide adsorption capacity of 0.5 millimole per gram (mmol/g) to 3.5 mmol/g. The carbon nanosheets form a porous foam with perforated carbon nanosheet cell walls.

In some embodiments, the perforated carbon nanosheets have an average pore diameter of 0.3 nm to 0.5 nm.

In some embodiments, the perforated carbon nanosheet cell walls have interconnected networks of open cells.

In some embodiments, the perforated carbon nanosheets have a D-band to G-band ratio of 0.5 is to 0.9.

In some embodiments, the perforated carbon nanosheets have a Brunauer-Emmett-Teller (BET) surface area of 100 square meters per gram (m²/g) to 400 m²/g.

In some embodiments, the perforated carbon nanosheets have a total pore volume of 0.150 cubic centimeter per gram (cm³/g) to 0.350 cm³/g.

In some embodiments, the perforated carbon nanosheets have a Horvath-Kawazoe micropore volume of 0.030 cm³/g to 0.200 cm³/g.

In some embodiments, 30% to 65% of the pores in the perforated carbon nanosheets are micropores based on the total pore volume.

In some embodiments, the perforated carbon nanosheets have a carbon dioxide adsorption capacity of 1 mmol/g to 3 mmol/g at a temperature of 0° C. and at a pressure of 1 bar.

In some embodiments, the perforated carbon nanosheets have a carbon dioxide adsorption capacity of 0.6 mmol/g to 1.7 mmol/g at a temperature of 25° C. and at a pressure of 1 bar.

In some embodiments, the perforated carbon nanosheets have a carbon dioxide working capacity of 0.8 to 1.6 mmol/g at a temperature of 0° C.

In some embodiments, the mass ratio of Corchorus olitorius to activation agent is 1:4, the heating temperature is 700° C., the heating time is 5 hours, and the perforated carbon nanosheets have a carbon dioxide adsorption capacity of 2.4 mmol/g to 2.6 mmol/g and a carbon dioxide working capacity of 1.45 mmol/g to 1.60 mmol/g at a temperature of 0° C.

In some embodiments, the perforated carbon nanosheets have a selectivity of 28 to 58 based on a fraction of carbon dioxide adsorption capacity over nitrogen adsorption capacity multiplied by a fraction of nitrogen partial pressure over carbon dioxide partial pressure at a temperature of 0° C.

In some embodiments, the mass ratio of Corchorus olitorius to activation agent is 1:4, the heating temperature is 600° C., the heating time is 5 hours, and the perforated carbon nanosheets have a selectivity of 53 to 55 based on a fraction of carbon dioxide adsorption capacity over nitrogen adsorption capacity multiplied by a fraction of nitrogen partial pressure over carbon dioxide partial pressure at a temperature of 0° C.

In some embodiments, the perforated carbon nanosheets have a regenerability of 58% to 70% based on the carbon dioxide working capacity and carbon dioxide adsorption capacity at a temperature of 0° C.

In some embodiments, the perforated carbon nanosheets have a regenerability of 65% to 75% based on the carbon dioxide working capacity and carbon dioxide adsorption capacity at a temperature of 25° C.

In some embodiments, the perforated carbon nanosheets have a sorbent selection parameter of 120 to 670 based on a fraction the carbon dioxide adsorption capacity divided by the nitrogen adsorption capacity squared over the carbon dioxide desorption capacity divided by the nitrogen desorption capacity multiplied by a fraction of the carbon dioxide working capacity over the nitrogen working capacity at a temperature of 0° C.

In some embodiments, the mass ratio of Corchorus olitorius to activation agent is 1:4, the heating temperature is 600° C., the heating time is 5 hours, and the perforated carbon nanosheets have a sorbent selection parameter of 655 to 660 based on a fraction the carbon dioxide adsorption capacity divided by the nitrogen adsorption capacity squared over the carbon dioxide desorption capacity divided by the nitrogen desorption capacity multiplied by a fraction of the carbon dioxide working capacity over the nitrogen working capacity at a temperature of 0° C.

In some embodiments, the mass ratio of Corchorus olitorius to activation agent is 1:4, the heating temperature is 500° C., the heating time is 5 hours, and the perforated carbon nanosheets have a sorbent selection parameter of 235 to 240 based on a fraction the carbon dioxide adsorption capacity divided by the nitrogen adsorption capacity squared over the carbon dioxide desorption capacity divided by the nitrogen desorption capacity multiplied by a fraction of the carbon dioxide working capacity over the nitrogen working capacity at a temperature of 25° C.

In some embodiments, the carbonate salt is sodium bicarbonate.

These and other aspects of the non-limiting embodiments of the present disclosure will become apparent to those skilled in the art upon review of the following description of specific non-limiting embodiments of the disclosure in conjunction with the accompanying drawings. The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure (including alternatives and/or variations thereof) and many of the attendant advantages thereof will be readily obtained as the same becomes better understood by reference to the following detailed description when considered in connection with the accompanying drawings, wherein:

FIG. 1 is a flowchart illustrating a method for preparing carbon nanosheets using dried and pulverized Corchorus olitorius sticks, according to certain embodiments;

FIG. 2A illustrates X-ray diffraction (XRD) patterns of jute derived carbons (JDCs) prepared at various pyrolysis temperatures (JDC-500, JDC-600, JDC-700), according to certain embodiments;

FIG. 2B illustrates Raman spectra of the JDCs prepared at various pyrolysis temperatures (JDC-500, JDC-600, JDC-700), according to certain embodiments;

FIG. 3 illustrates Fourier-transform infrared (FTIR) spectra of the JDCs at various pyrolysis temperatures (JDC-500, JDC-600, JDC-700), according to certain embodiments;

FIG. 4A illustrates a field emission scanning electron microscopy (FESEM) micrograph of the JDC-500, according to certain embodiments;

FIG. 4B illustrates an FESEM micrograph of the JDC-600, according to certain embodiments;

FIG. 4C illustrates an FESEM micrograph of the JDC-700, according to certain embodiments;

FIG. 5A illustrates nitrogen gas adsorption isotherm of the JDC-500, JDC-600, and JDC-700 at −196.15° C., according to certain embodiments;

FIG. 5B illustrates a plot of the density functional theory (DFT) pore size distribution of the JDC-500, JDC-600, and JDC-700, according to certain embodiments;

FIG. 6A illustrates a plot of Langmuir and dual-site Langmuir fitting of the JDC-500 isotherm at 0° C., according to certain embodiments;

FIG. 6B illustrates carbon dioxide and nitrogen adsorption isotherms of the JDC-500, JDC-600, and JDC-700 at 0° C., according to certain embodiments;

FIG. 6C illustrates carbon dioxide and nitrogen adsorption isotherms of the JDC-500, JDC-600, and JDC-700 at 25° C., according to certain embodiments; and

FIG. 6D illustrates a plot of the selectivity of the JDC-500, JDC-600, and JDC-700 for CO₂ and N₂ at various temperature and pressures, according to certain embodiments.

### DETAILED DESCRIPTION

In the following description, it is understood that other embodiments may be utilized, and structural and operational changes may be made without departure from the scope of the present embodiments disclosed herein.

When describing the present disclosure, the terms used are to be construed in accordance with the following definitions, unless a context dictates otherwise. Embodiments of the present disclosure will now be described more fully hereinafter with reference to the accompanying drawings wherever applicable in which some, but not all, embodiments of the disclosure are shown.

Reference will now be made to specific embodiments or features, examples of which are illustrated in the accompanying drawings. In the drawings, whenever possible, corresponding or similar reference numerals will be used to designate identical or corresponding parts throughout the serval views. Moreover, references to various elements described herein are made collectively or individually when there may be more than one element of the same type; however, such references are merely exemplary in nature. It may be noted that any reference to elements in the singular may also be constructed to relate to the plural and vice-versa without limiting the scope of the disclosure to the exact number or type of such elements unless set forth explicitly in the appended claims. Further, as used herein, the use of the singular includes plural and the words “a,” “an,” and the like generally carry a meaning of “one or more,” and “at least one,” unless stated otherwise.

Furthermore, the terms “approximately,” “approximate,” “about,” and similar terms generally refer to ranges that include the identified value within a margin of 20%, 10%, or preferably 5%, and any values therebetween.

The use of the terms “include,” “includes,” “including,” “have,” “has,” or “having” should be generally understood as open-ended and non-limiting unless specifically stated otherwise.

As used herein, the term “isotherm” may refer to a line on a chart representing changes of volume or pressure under conditions of constant temperature a certain time or on average over a certain period of time.

As used herein, the term “adsorption isotherm” refers to the relationship between the adsorbate(s) (i.e., CO₂ and/or N₂) in the surrounding phase and adsorbate(s) adsorbed on the surface of the adsorbent (i.e., the JDCs) at equilibrium and constant temperature. Adsorption isotherms may be used to describe how adsorbates interact with adsorbents.

As used herein, the term “Langmuir isotherm” or “Langmuir adsorption isotherm” may refer to a model or mathematical formulation used to explain adsorption. A Langmuir adsorption model assumes the adsorbate(s) behaves as an ideal gas at isothermal conditions. A Langmuir isotherm may be used to predict the capacity of adsorption of a certain material.

As used herein, the term “precursor material” refers to any carbon-based or carbon-containing material that may become transformed into a solid porous carbon mass upon pyrolysis and/or carbonization. A precursor is any compound that participates in a chemical reaction that produces another compound.

As used herein, the term “pyrolysis” refers to the thermal decomposition of precursor material at elevated temperatures under inert conditions in which the precursor material is converted substantially to a carbon solid. Pyrolysis is often used to convert an organic material, such as biomass, to a carbon mass.

As used herein, the term “activation” refers to the treatment of precursor material with certain chemicals during or before pyrolysis.

As used herein, the term “activation agent” refers to a chemical used to treat precursor material during pyrolysis. An activation agent may be used to increase a desired chemical or physical property of the precursor material.

As used herein, the term “carbon nanosheets” refers to a two-dimensional carbon nanostructure with thicknesses of 2 nanometers or less. The thickness of the carbon nanosheets may vary from a single graphene layer to two, three, four, or more layers.

As used herein, the term “pulverize” refers to pounding, crushing, cutting, grinding, beating, or otherwise reducing a larger particle-size substance into a smaller particle-size substance.

As used herein, the term “hysteresis loop” refers to the relationship between the adsorption and desorption of the adsorbates on the surface of the adsorbates. A hysteresis loop may describe a degree of order and disorder in micropores.

As used herein, the term “ramping rate” or “ramp rate” refers to a plot of temperature versus time. The ramp rate is expressed by the slope of the curve. The ramp rate is expressed as a change in temperature over a change in time. A steeper curve represents a higher ramp rate and means that a specific temperature range can be covered in a shorter time. Ramp rates are typically expressed in ° C./second, ° C./minute, or ° C./hour.

As used herein, the term “sorbent selection parameter” may refer to a dimensionless parameter(S) proposed for comparing the performance of two or more adsorbents for a particular binary gas separation by vacuum swing adsorption (VSA). The sorbent selection parameter considers working capacity, selectivity, and regenerability to provide a single empirical value for comparison. A higher sorbent selection value indicates a greater suitability for a VSA process under given conditions.

Aspects of the present disclosure are directed towards the preparation of carbon nanosheets using jute stick-derived carbons (JDCs) as high-performance adsorbents for CO₂ capture. The carbon nanosheets were produced by pyrolyzing powdered jute sticks with a carbonate-containing material such as NaHCO₃ as an activating agent at temperatures ranging from 500 to 700° C. By adjusting the pore size distribution and surface functionalization, adsorption capacities of up to 2.5 mmol/g and selectivities for CO₂ over N₂ of up to 54 were achieved for the JDCs. The working capacities, regenerability, and potential for CO₂ separation using a vacuum swing adsorption process for the JDCs were also evaluated.

In an embodiment, the carbon nanosheets may be prepared from raw materials, including preferably 50%, preferably 60%, preferably 70%, preferably 75%, preferably 80%, preferably 85%, preferably 90%, preferably 91%, preferably 92%, preferably 92.5%, preferably 93%, preferably 94%, preferably 95%, preferably 96%, preferably 97%, preferably 97.5%, preferably 98%, preferably 99%, preferably 99.1%, preferably 99.5%, more preferably about 99.9%, or yet more preferably about 100% by weight of jute sticks, which may be the stalks, stems, trunk, branches, and/or the like of jute or typically the less fibrous material left behind after removal of the jute fibers, ribbons, and the like, generally post-retting.

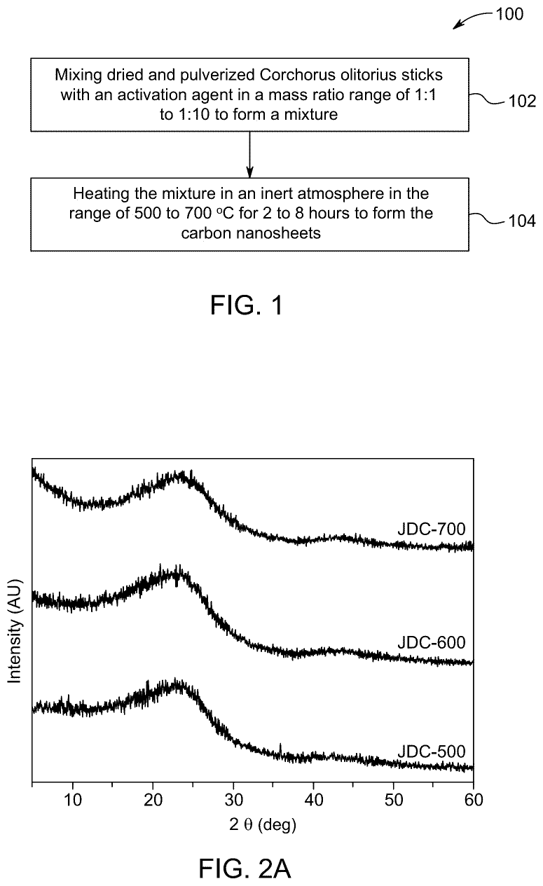

FIG. 1 illustrates a flow chart depicting a method 100 for preparing carbon nanosheets is illustrated. The order in which the method 100 is described is not intended to be construed as a limitation, and any number of the described method steps may be combined in any order to implement the method 100. Additionally, individual steps may be removed or skipped from the method 100 without departing from the spirit and scope of the present disclosure.

The present disclosure is directed to methods of preparing carbon nanosheets from jute (Corchorus olitorius) sticks. Corchorus olitorius, commonly known as jute mallow or nalita jute, is a species of shrub found in Africa and Asia. Various parts of C. olitorius, such as the trunk, stems, roots, leaves, fruits, pulp, offshoots, and the like may by processed for different materials for different purposes.

At step 102, the method 100 includes mixing dried and pulverized Corchorus olitorius sticks with an activation agent in a mass ratio range of 1:1 to 1:10 to form a mixture. The dried and pulverized jute sticks may be obtained by collection. The collected or otherwise obtained jute sticks are cut and/or chopped into small pieces and optionally rinsed and/or cleaned with water. The water may be tap water, distilled water, double distilled water, deionized water, water purified by reverse osmosis, and the like. In a preferred embodiment, the water is deionized water. In an embodiment, the Corchorus olitorius sticks are cut, chopped, ground, and/or chipped to a size of about 1 to 5 cm, preferably 2 to 4 cm, preferably 2 to 3 cm, washed, and subsequently dried in an oven at 90 to 140° C., preferably 95 to 130° C., preferably 100 to 120° C., preferably about 100 to 110° C., preferably about 100° C. to reduce the moisture content to below about 5 wt. %, preferably below 4 wt. %, preferably below 3 wt. %, more preferably below 2 wt. %, and yet more preferably below about 1 wt. %. The Corchorus olitorius sticks may be cut, chopped, ground, and/or chipped manually with hands, a knife, or the like. The cut Corchorus olitorius sticks may be dried for any amount of time that provides an adequately dried product, typically, for drying times of 12 to 72 hours, preferably 18 to 48 hours, and more preferably about 24 hours.

The dried Corchorus olitorius sticks are further pulverized using any suitable means, for example, by grinding, ball milling, blending, shredding, and the like, using manual methods (e.g., mortar), machine-assisted methods such as using a mechanical blender, mixer, grinder, and/or any other apparatus known to those of ordinary skill in the art. The dried Corchorus olitorius sticks are preferably pulverized until an average particle size of less than 100 μm is achieved. In an embodiment, the Corchorus olitorius sticks are pulverized for 1 to 30 minutes, preferably 2 to 20 minutes, preferably 3 to 10 minutes, preferably 3 to 7 minutes, or preferably about 5 minutes. The Corchorus olitorius sticks are sieved through mesh with a size of 50 to 500 μm, preferably 60 to 400 μm, preferably 70 to 300 μm, preferably 80 to 200 μm, more preferably 90 to 120 μm, and yet more preferably about 100 μm. In preferred embodiments, the dried Corchorus olitorius sticks are then mixed in the presence of the activation agent. The activation agent is a carbonate salt, including, but not limited to, sodium carbonate, sodium bicarbonate, potassium carbonate, potassium bicarbonate, cesium bicarbonate, magnesium bicarbonate, calcium bicarbonate, the like, and a combination thereof. In a preferred embodiment, the activation agent is sodium bicarbonate. In an embodiment, the mixing of the dried Corchorus olitorius sticks with the activation agent is for 1 to 30 minutes, preferably 2 to 20 minutes, preferably 3 to 10 minutes, preferably 3 to 7 minutes, or preferably about 5 minutes to form a mixture that is homogeneous in form. In some embodiments, the weight ratio of dried Corchorus olitorius sticks to the activation agent ranges from 1:1 to 1:10, preferably 1:2 to 1:8, preferably 1:3 to 1:6, preferably 1:4 to 1:5, and more preferably about 1:4.

At step 104, the method 100 includes heating the mixture in an inert atmosphere, in the temperature range of 500° C. to 700° C., for a time interval for 2 to 8 hours to form the carbon nanosheets. In an embodiment, the heating is carried out in an inert atmosphere at about 400 to 800° C., preferably 450 to 750° C., preferably 500 to 700° C., preferably about 500° C., preferably about 600° C., and preferably about 700° C. This process is called pyrolysis. Pyrolysis is a process of thermochemical decomposition of the dried Corchorus olitorius sticks at elevated temperatures and in the absence of an oxidizing agent such as oxygen, hydrogen peroxide, and/or a halogen-containing gas (e.g., a chlorine-containing gas). In some embodiments, pyrolysis is performed in an inert gas (e.g., nitrogen, helium, neon, and/or argon), preferably nitrogen, and in a temperature range of 400 to 800° C., preferably 425 to 775° C., preferably 450 to 750° C., preferably 500 to 700° C., preferably about 500° C., preferably about 600° C., or preferably about 700° C.

In some embodiments, pyrolysis may be performed by placing the mixture into a furnace such as a tube (quartz) furnace, for example, in a ceramic crucible (e.g., an alumina crucible) or other forms of containment, and heating to the temperatures described above. The furnace is preferably equipped with a temperature control system, which may provide a heating rate of up to 50° C./min, preferably up to 40° C./min, preferably up to 30° C./min, preferably up to 20° C./min, preferably up to 10° C./min. In preferred embodiments, the mixture is heated with a heating rate in the range of 1 to 20° C./min, preferably 3 to 15° C./min, preferably 5 to 12° C./min, and more preferably about 10° C. to an elevated temperature described above. The mixture is heated at such an elevated temperature (e.g., 500-700° C.) for 1 to 15 hours, preferably 2 to 10 hours, preferably 3 to 8 hours, preferably 4 to 6 hours, and more preferably about 5 hours. The furnace may also be equipped with a cooling accessory such as a cooling air stream system, or a liquid nitrogen stream system, which may provide a cooling rate of up to 20° C./min, preferably up to 15° C./min, preferably up to 10° C./min, preferably up to 5° C./min. In an embodiment, the mixture is cooled at a ramp down cooling rate in the range of 1 to 15° C./min, preferably 3 to 10° C./min, preferably 4 to 7° C./min, and more preferably about 5° C./min to a temperature in a range 20 to 80° C., preferably 30 to 70° C., preferably 40 to 60° C., and more preferably until the temperature was at or below 50° C. Pyrolysis of the pulverized Corchorus olitorius sticks preferably forms a solid, for example, a carbonaceous ash, char, tar that mainly contains carbon nanosheets of JDCs. The pyrolysis of the pulverized Corchorus olitorius sticks may also form volatile compounds, which may evaporate during the pyrolysis.

The pyrolyzed Corchorus olitorius sticks may be treated with an acid solution. The acid solution may comprise hydrochloric acid, hydrobromic acid, hydroiodic acid, sulfuric acid, nitric acid, phosphoric acid, the like, and a combination thereof. In a preferred embodiment, the acid solution may have a concentration of 0.1 to 10 M, preferably 0.2 to 2 M, preferably 0.3 to 1 M, and more preferably about 0.5 M. The pyrolyzed Corchorus olitorius sticks may be treated with the acid solution using any known agitation method known to those of ordinary skill in the art, for example, via stirring, swirling, mixing, sonicating (e.g., ultrasonication or sonication). The pyrolyzed Corchorus olitorius sticks may be treated with the acid solution 1 to 5 times, preferably 2 to 4 times, and more preferably 2 to 3 times. Treatment times may range from 5 to 60 minutes, preferably 10 to 30 minutes, or preferably 15 to 20 minutes. The treated Corchorus olitorius sticks may be washed with water for 1 to 5 times, preferably 2 to 4 times, preferably about 3 times, and further dried at 50 to 80° C., preferably 55 to 75° C., preferably 60 to 70° C., and more preferably about 60° C. for 6 to 15 hours, preferably 10 to 13 hours, and more preferably about 12 hours to form the carbon nanosheets. It is preferred that the drying is carried out under a vacuum to prevent air oxidation. In some embodiments, carbon nanotubes, carbon nanorods, and/or carbon nanofibers, may be formed as well.

The carbon nanosheets form a porous foam with the perforated cell walls of the carbon nanosheets, and the porous foam has interconnected networks of open cells. In some embodiments, the carbon nanosheets have a pore diameter of preferably 0.1 nm to 1.0 nm, more preferably 0.2 to 0.7 nm, and yet more preferably 0.3 to 0.5 nm. The pore diameter refers to the internal structural spacing present in the carbon nanosheets. In some embodiments, the interconnected networks of open cells may comprise holes, cavities, or perforations with a diameter of 1 to 500 nm, preferably 20 to 400 nm, preferably 50 to 300 nm, or preferably 100 to 200 nm. The perforations may allow gas to adsorb on to the surface of the carbon nanosheets. In some embodiments, the perforations may have a depth of 5 to 500 nm, preferably, 10 to 250 nm, preferably 20 to 100 nm, or preferably 40 to 80 nm.

In some embodiments, the carbon nanosheets have a total pore volume of 0.150 to 0.350 cm³/g, more preferably 0.160 to 0.3 cm³/g, and yet more preferably 0.170 to 0.29 cm³/g. The carbon nanosheets have a Horvath-Kawazoe micropore volume of 0.030 to 0.200 cm³/g, more preferably 0.040 to 0.19 cm³/g, and yet more preferably 0.050 to 0.180 cm³/g.

The carbon nanosheets formed by the present disclosure include mesopores and micropores, with 30 to 65%, preferably 31 to 63%, of pores in the carbon nanosheets being micropores based on the total pore volume. In general, the Horvath-Kawazoe equation describes the additional amount of gas adsorbed into the pores due to capillary action.

The Brunauer-Emmett-Teller analysis shows that the carbon nanosheets have a surface area in the range of 100 to 400 m²/g, preferably 110 to 350 m²/g, preferably 120 to 340 m²/g, more preferably 140 to 335 m²/g, and yet more preferably 141 m²/g to 334 m²/g.

In some embodiments, the carbon nanosheets have a D-band to G-band ratio of 0.5 to 0.9, preferably 0.55 to 0.85, and more preferably 0.6 to 0.8. As used herein, the term “D-band” and “G-band” refers to features in Raman spectroscopy. the D- and G-bands in Raman spectroscopy are specific peaks that are commonly referred to for carbon materials. The G band is a result of in-plane vibrations of sp²-bonded carbon atoms, while the D band is due to out-of-plane vibrations attributed to the presence of structural defects. The D band is also known as the disorder band and is often used as a measure of the amount of disorder in a sample.

The carbon nanosheets have a CO₂ adsorption rate capacity of 0.5 to 3.5 mmol/g, preferably 0.6 to 2.5 mmol/g. In some embodiments, the carbon nanosheets have a CO₂ adsorption capacity of 1 to 3 millimole per gram (mmol/g), preferably 1.2 to 2.6 mmol/g, at a temperature of 0° C. and at a pressure of 1 bar. In other embodiments, the carbon nanosheets have a CO₂ adsorption rate capacity in the range of 0.6 to 1.7 mmol/g, preferably 0.7 to 1.6 mmol/g, at room temperature (25° C.) and at a pressure of 1 bar. In addition, the carbon nanosheets have a nitrogen adsorption capacity of 0.01 to 0.30 mmol/g, preferably 0.05 to 0.25 mmol/g at a temperature of 0° C. and at a pressure of 1 bar. The carbon nanosheets have a nitrogen adsorption capacity in the range of 0.01 to 0.25 mmol/g, preferably 0.05 to 0.2 mmol/g at room temperature (25° C.) and at a pressure of 1 bar. Further, the carbon nanosheets have a carbon dioxide working capacity of 0.8 to 1.6 mmol/g, preferably 0.9 to 1.55 mmol/g at a temperature of 0° C. The carbon nanosheets have a carbon dioxide working capacity in the range of 0.4 to 1.2 mmol/g, preferably 0.5 to 1.15 mmol/g at room temperature (25° C.).

In some embodiments, the carbon nanosheets have a selectivity of 28 to 58, preferably 29 to 57, preferably 30 to 56, and more preferably 32 to 55, based on a fraction of carbon dioxide adsorption capacity over nitrogen adsorption capacity multiplied by a fraction of nitrogen partial pressure over carbon dioxide partial pressure at a temperature of 0° C. The carbon nanosheets have a selectivity of 18 to 34, preferably 19 to 33, preferably 20 to 32, and more preferably 21 to 31, based on the fraction of carbon dioxide adsorption capacity over nitrogen adsorption capacity multiplied by the fraction of nitrogen partial pressure over carbon dioxide partial pressure at a temperature of 25° C.

In some embodiments, the carbon nanosheets have a regenerability of 58 to 70%, preferably 59 to 69%, preferably 60 to 67%, and more preferably 61 to 66%, based on the carbon dioxide working capacity and carbon dioxide adsorption capacity at a temperature of 0° C. The carbon nanosheets have a regenerability of 65 to 75%, preferably 66 to 74%, preferably 67 to 73%, and more preferably 68 to 73% at room temperature (25° C.). In an embodiment, the carbon nanosheets have a sorbent selection parameter of 120 to 670, preferably 130 to 665, preferably 140 to 660, based on a fraction the carbon dioxide adsorption capacity divided by the nitrogen adsorption capacity squared over the carbon dioxide desorption capacity divided by the nitrogen desorption capacity multiplied by a fraction of the carbon dioxide working capacity over the nitrogen working capacity at a temperature of 0° C. In an embodiment, the carbon nanosheets have a sorbent selection parameter of 100 to 250, preferably 110 to 245, preferably 115 to 240, based on a fraction the carbon dioxide adsorption capacity divided by the nitrogen adsorption capacity squared over the carbon dioxide desorption capacity divided by the nitrogen desorption capacity multiplied by a fraction of the carbon dioxide working capacity over the nitrogen working capacity at a temperature of 25° C.

### EXAMPLES

### Example 1: Materials

The jute (Corchorus olitorius) sticks were collected from Mominpur, Keshabpur, Jessore in Bangladesh's western region. The jute sticks were extracted from jute plants using the retting process. In general, retting is a process employing the action of micro-organisms and moisture on plants to dissolve or rot away much of the cellular tissues and pectins surrounding bast-fiber bundles, facilitating the separation of the fiber from the stem. NaHCO₃ (>99% Sigma-Aldrich) and N₂ (99.999%, Specialty Gases Company Limited, Saudi Arabia) were used. Deionized water was also used.

### Example 2: Preparation of Jute-Derived Carbons (JDCs)

JDCs were prepared by modifying an earlier reported procedure [Shah, S. S.; Cevik, E.; Aziz, M. A.; Qahtan, T. F.; Bozkurt, A.; Yamani, Z. H., Jute sticks derived and commercially available activated carbons for symmetric supercapacitors with bio-electrolyte: a comparative study. Synthetic Metals, 2021, incorporated herein by reference in its entirety]. In particular, the jute sticks were cut into small pieces (2-3 cm length), cleaned with deionized water, and dried overnight in a convection oven set at 100° C. Further, the dried jute sticks were pulverized using a household blender and sifted through a 100 μm mesh sieve to obtain fine powders of particle size less than, equal to, but not exceeding 100 μm. These powders were mixed with NaHCO₃ in a mass ratio of 1:4 and pyrolyzed at three different temperatures of 500° C., 600° C., and 700° C. for 5 hours under a flowing stream of N₂ at 60 standard cubic centimeters per minute (sccm/min) in a quartz tube furnace. Final pyrolysis temperatures were achieved at the ramping rate of 10° C./min and, after completion of the dwell time, the carbonized blend was cooled to a temperature of below about 50° C. The nitrogen flow was maintained until the temperature was below 50° C. The carbonized blend was then removed from the furnace and washed twice with 0.5 M HCl, followed by washing with deionized water until the pH of the washed materials approached neutrality (a pH of about 7 to 9). Finally, the materials were dried at 60° C. for 12 hours under vacuum to obtain the jute-derived carbons (JDCs). The prepared materials were coded as JDC-500, JDC-600, and JDC-700, where 500, 600, and 700 indicate the pyrolysis temperatures in ° C.

### Example 3: Characterization

The physicochemical and surface properties of the prepared materials were measured using appropriate characterization techniques. Insights into crystal structures were obtained from powder X-ray diffraction (XRD) using a Rigaku Miniflex-II diffractometer (manufactured by Rigaku, Japan) fitted with copper-potassium (Cu-Kα) anode (λ=0.15416 nm). XRD diffractograms of the dry fine powders were collected in the 20 range of 5° to 70° at a scan rate of 2°/min and a step size of 0.02°. The presence of functional groups was examined by Fourier-transform infrared (FTIR) spectroscopy using a Nicolet 6700 (Thermo Fisher Scientific, USA) FTIR instrument. For each measurement, 20 scans were taken in the range of 4000 cm⁻¹ to 400 cm⁻¹ with a spectral resolution of 4 cm⁻¹. The morphological features were evaluated using a high-resolution field-emission scanning electron microscopy (FESEM) TESCAN-LYRA-3 (manufactured by Tescan, Czech Republic). Raman spectra were collected in the range of 800 cm⁻¹ to 2000 cm⁻¹ using iHR320 HORIBA Raman spectrometer to determine the degree of graphitization in samples. N₂ and CO₂ adsorption measurements were carried out at a temperature of −196.15° C. for surface area and pore characterization determination in the Quadrasorb SI (Quantachrome Instruments, US). Prior to the surface area analysis, 100 mg to 200 mg of the sample was degassed at 130° C. for 24 hours under a high dynamic vacuum (10⁻⁵ bar).

### Example 4: CO₂ and N₂ Isotherm Measurements

The CO₂ and N₂ adsorption and desorption isotherms of the prepared materials were carried out in Quadrasorb SI (Quantachrome Instruments, US) at 0° C. and 25° C. Prior to the analysis, around 200 mg of the samples were degassed at 130° C. under a dynamic vacuum for 24 hours and then cooled to room temperature and weighed again. Before the isotherm measurements, additional in-situ degassing was carried out at 70° C. for 3 hours under a dynamic vacuum. The isotherm temperature for isotherms was maintained by using a circulation bath containing a 1:1 mixture of water and ethylene glycol as a heat transfer fluid. The experimental isotherm data was fitted with Langmuir and Dual Site Langmuir models to gain insights into surface interactions [Hanif, A.; Dasgupta, S.; Nanoti, A., Facile synthesis of high-surface-area mesoporous MgO with excellent high-temperature CO₂ adsorption potential. Industrial & Engineering Chemistry Research, 2016; and Hanif, A.; Dasgupta, S.; Divekar, S.; Arya, A.; Garg, M. O.; Nanoti, A., A study on high-temperature CO₂ capture by improved hydrotalcite sorbents. Chemical Engineering Journal, 2014, both of which are incorporated herein by reference in their entireties]. Besides the determination of adsorption capacity of CO₂ and N₂, the isotherms results were used to calculate other determinants of the adsorbent performance such as, but may not be limited to, CO₂ working capacity, regenerability, CO₂ over N₂ selectivity and sorbent selection parameter. The calculations and equations (1-4) used for the analysis are given below:

$${CO}_{2} working capacity , ( mmol / g ) {W}_{CO 2} = {n}_{CO 2}^{ads} - {n}_{CO 2}^{des} \qquad ( 1 )$$

$$Regenerability , ( \% ) R = ( \frac{{W}_{CO 2}}{{n}_{CO 2}^{ads}} ) \times 100 \qquad ( 2 )$$

$$Selectivity , {a}_{CO 2 / N 2} = ( \frac{{n}_{CO 2}^{ads}}{{n}_{N 2}^{ads}} ) ( \frac{{p}_{N 2}}{{p}_{CO 2}} ) \qquad ( 3 )$$

$$Sorbent Selection Parameter , S = ( {( {α}_{CO 2 / N 2}^{ads} )}^{2} / ( {α}_{CO 2 / N 2}^{des} ) ) * ( {W}_{CO 2} / {W}_{N 2} ) \qquad ( 4 )$$

where, n_{CO2}^{ads} (mmol/g) is CO₂ capacity obtained in the adsorption isotherm, n_{CO2}^{des} is the capacity obtained from desorption arm of the isotherm at the lower operational pressure in pressure swing adsorption (PSA) or vacuum swing adsorption (VSA) process, p_{N2} the partial pressure of N₂, and p_{CO2} is the partial pressure of CO₂ in the process stream.

Developing micropores with a size of less than 1 nm is effective in enhancing the CO₂ adsorption of carbon-based adsorbents in which the micropores are present. Traditionally these micropores are introduced by a post-synthesis treatment of carbons with CO₂ or steam at a high temperature of about 500° C. to 900° C. [Igalavithana, A. D.; Choi, S. W.; Shang, J.; Hanif, A.; Dissanayake, P. D.; Tsang, D. C.; Kwon, J.-H.; Lee, K. B.; Ok, Y. S., Carbon dioxide capture in biochar produced from pine sawdust and paper mill sludge: Effect of porous structure and surface chemistry. Science of the total environment, 2020; and Vivo-Vilches, J. F.; Pérez-Cadenas, A. F.; Maldonado-Hódar, F. J.; Carrasco-Marin, F.; Faria, R. P.; Ribeiro, A. M.; Ferreira, A. F.; Rodrigues, A. E., Biogas upgrading by selective adsorption onto CO₂ activated carbon from wood pellets. Journal of environmental chemical engineering, 2017, both of which are incorporated herein by reference in their entireties].

During the CO₂ activation process, dissociative chemisorption occurs on the biochar surface, creating surface oxides and carbon monoxide (CO). These surface oxides are subsequently liberated from the surface and aid in micropore formation. On the other hand, in steam modification, the free active centers of the carbon center receive oxygen from water molecules leading to their dissociation and release of hydrogen gas (H₂). Further, hydrogen also reacts with the carbon surface to create surface hydrogen complexes. These active surface complexes formed by incomplete pyrolysis products are released leaving behind high microporosity carbons [Wang, J. and Wang, S., Preparation, modification and environmental application of biochar: A review. Journal of Cleaner Production, 2019, incorporated herein by reference in its entirety]. The activation methods involving CO₂ and steam pose several challenges including the need for a two-step preparation process and a consistent supply of high purity CO₂ and steam at high temperatures for several hours, during which a small amount of the steam and CO₂ may react with the carbon. Additionally, when synthesizing a larger batch of carbon, the material may not receive uniform exposure to activating gas, leading to decreased efficiency and questionable reproducibility of the activation process. Unlike the conventional methods, the single step carbonization-activation preparation strategy of the present disclosure, which involves uniformly blending NaHCO₃ with the carbon source can lead to in situ generation of CO₂ and H₂O by the thermal decomposition of NaHCO₃ as per the following reaction: [Hartman, M.; Svoboda, K.; Pohořelý, M.; Šyc, M., Thermal decomposition of sodium hydrogen carbonate and textural features of it's calcines. Industrial & Engineering Chemistry Research, 2013]

2NaHCO₃→Na₂CO₃+CO₂(g)+H₂O(g)

The decomposition takes place from 100° C. but is faster at higher temperatures. In the disclosed preparation strategy we used a high ramp rate of 10° C./min thereby coinciding carbonization with activation to effectively utilize CO₂ and H₂O for micropore generation. This strategy also removes the limitations of non-uniform exposure of carbons to activating agents typically encountered in the case of activation by flowing CO₂ and steam. Additionally, Na₂CO₃ formed because of the thermal decomposition of NaHCO₃ can be potentially recovered from the washing solvent and reused again. The adsorbents were thus expected to have desirable physicochemical properties for CO₂ adsorption.

The gas adsorption properties of the adsorbents are intricately dictated by the physicochemical and surface properties of adsorbents. Therefore, adsorbents were characterized by different techniques to understand the impact of different preparation parameters on the properties of adsorbents and their subsequent CO₂ capture performance.

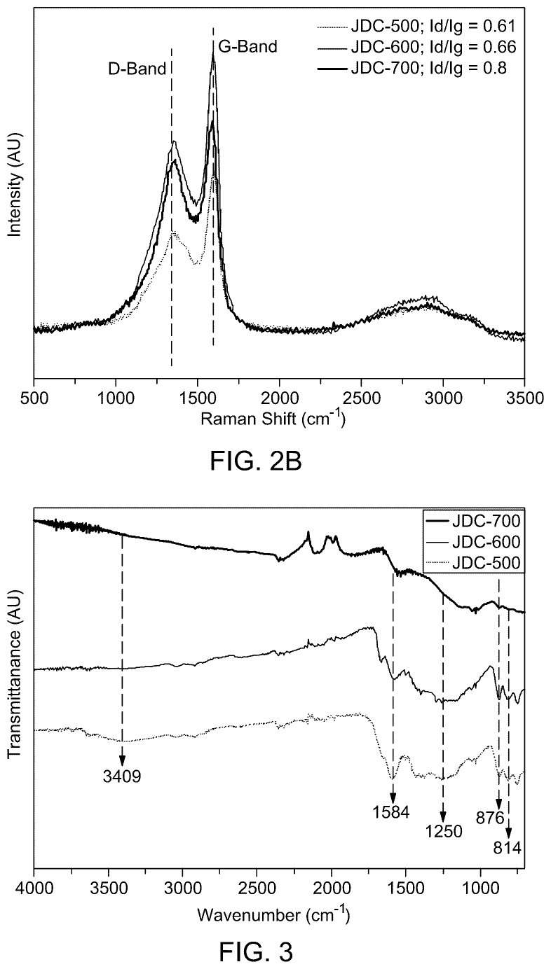

Referring to FIG. 2A, XRD diffractograms of JDCs synthesized at various temperatures is illustrated. As can be seen from FIG. 2A, a broad hump centred around 20=25° is indicative of a poor crystalline solid and a low degree of graphitization. Since all samples show similar XRD with no well-defined peaks, it can be concluded from FIG. 2A that these materials are predominantly amorphous.

Referring to FIG. 2B, Raman spectra of the JDCs synthesized at various temperatures is illustrated. As can be seen from FIG. 2B, the Raman spectra display two distinct bands at about 1580 cm⁻¹ and about 1350 cm⁻¹, known as D-band and G-band, respectively. The G-band is linked to the E₂g vibrational mode of the sp² C—C bond stretching within the plane, indicating the carbon's graphitic nature. The D-band signifies a peak of disorder with the A₁g vibrational mode, revealing defects in the graphitic lattice [Palaniselvam, T.; Aiyappa, H. B.; Kurungot, S., An efficient oxygen reduction electrocatalyst from graphene by simultaneously generating pores and nitrogen doped active sites. Journal of Materials Chemistry, 2012, incorporated herein by reference in its entirety]. By calculating the I^{d}/I_{g} ratio, which is the intensity ratio of D-band and G-band, defects can be assessed in carbon-based materials. A higher I_{d}/I_{g} ratio confirms a greater number of defects in the carbon sample, whereas a predominantly graphitic sample has I_{d}/I_{g} approaching zero [Kim, S.-G.; Park, O.-K.; Lee, J. H.; Ku, B.-C., Layer-by-layer assembled graphene oxide films and barrier properties of thermally reduced graphene oxide membranes. Carbon letters, 2013, incorporated herein by reference in its entirety]. For all the synthesized JDCs, the I_{d}/I_{g} values indicated disorder for all samples, which increases with the increases in pyrolysis temperature. JDC-500 has an I_{d}/I_{g} value of 0.61, JDC-600 has an La/I_{g} value of 0.66, and JDC-700 has an I_{d}/I_{g} value of 0.80.

FIG. 3 illustrates FTIR spectra obtained to understand the impact of pyrolysis temperature on the surface functionalization of the JDCs. As can be seen from FIG. 3, a broad peak around 3409 cm⁻¹ is observed, due to the —OH stretch. JDC-500 retains some —OH functionalities, whereas these functional groups are absent in JDC-600 and JDC-700. This indicates that higher pyrolysis temperatures decompose the —OH groups from the carbon surface. The presence of a peak at 1584 cm⁻¹ indicates the —C═C— stretch of the aromatic rings present in all three samples. Further, the emergence of the feeble bands at 1250 cm⁻¹, indicative of a —CO group, indicate a partial oxidation possibly by the steam generated from NaHCO₃ decomposition. Furthermore, surface aromatic —CH groups exhibited three faint bands between 750 cm⁻¹ and 876 cm⁻¹.

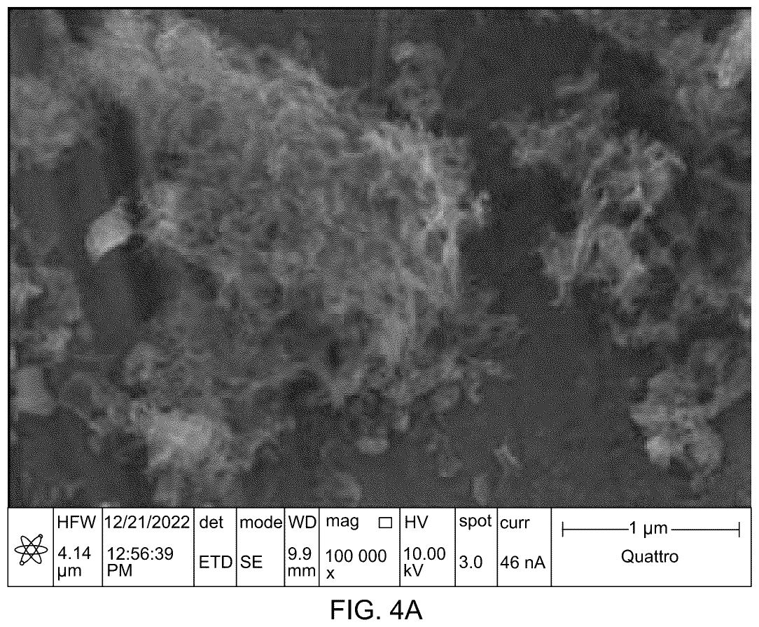

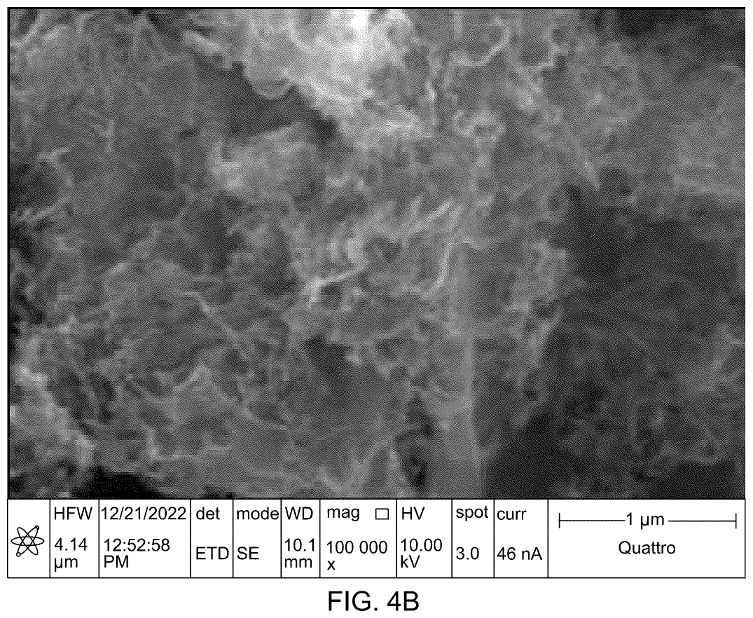

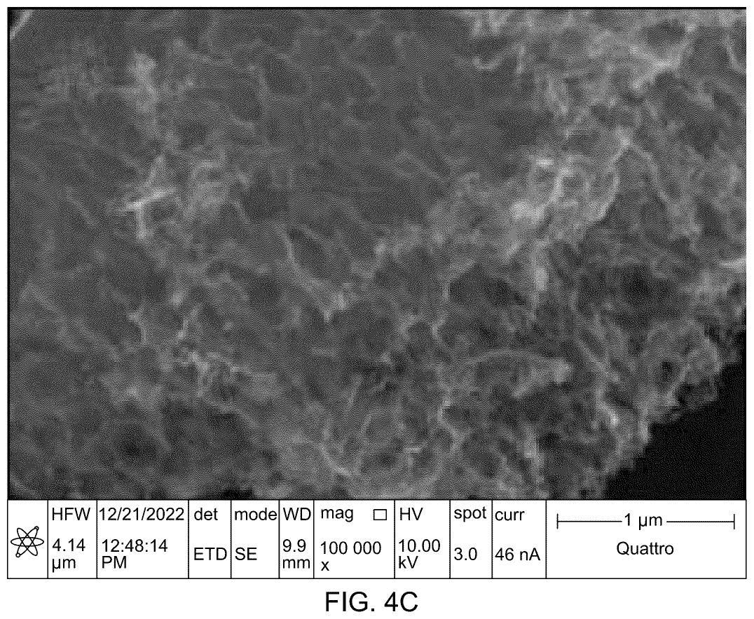

Referring to FIGS. 4A-4C, FESEM micrographs for JDCs synthesized at 500, 600, and 700° C., respectively, are illustrated. All materials show a porous foam type morphology formed of intricate interconnected network of perforated nanosheets (FIGS. 4A-4C).

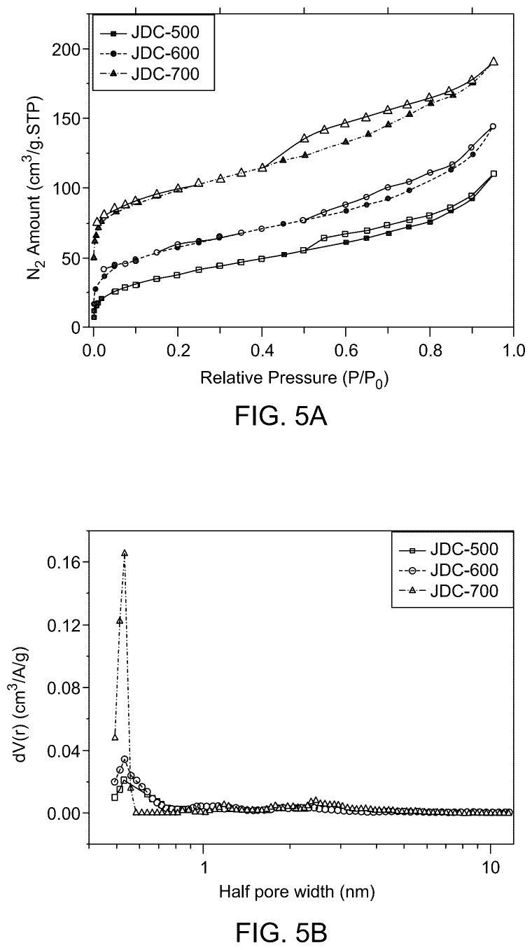

Referring to FIG. 5A, a graph depicting the N₂ adsorption isotherms of the JDCs is depicted. It is observed that as the pyrolysis temperature increases, the pores become denser due to the opening and partial oxidation of the carbons at higher temperatures. The surface and pore size properties are factors that affect the gas adsorption and separation performance. As can be seen from the FIG. 5A, the N₂ adsorption isotherm at −196.5° C. indicates pseudotype II isotherms with narrow H3 hysteresis loop indicative of both microporosity and mesoporosity in the sample.

Referring to FIG. 5B, a graph depicting the density functional theory (DFT) pore size distribution of the JDCs is illustrated. As can be seen from FIG. 5B, the graph indicates a predominant microporosity along with some amount of mesoporosity as well. Further, different amounts of N₂ adsorption are indicative of different surface areas of the samples in the following order: JDC-700>JDC-600>JDC-500. A closer examination of pore size distribution plots indicate that JDC-700 has a narrow micropore size distribution centered at around 0.5 nm, whereas JDC-500 and JDC-600 have a similar but comparatively broader micropore size distribution in the range of 0.4 nm to 0.96 nm.

Referring to Table 1, Brunauer-Emmett-Teller (BET) surface area and porosity measurements determined from N₂ adsorption at −196.15° C. are given. It can be concluded from Table 1, that the sample JDC-700 possesses the highest surface area, total pore volume, and micropore volume, followed by JDC-600 and JDC-500, respectively. However, the average pore diameter shows the reverse trend indicating JDC-500 has the highest value for average pore diameter followed by JDC-600 and JDC-700, respectively. This indicates that, all other factors remaining constant, higher pyrolysis temperature leads to a higher surface area and a higher proportion of micropores by volume. Both surface area and micropore volume are factors known to favor CO₂ adsorption on carbons.

| | S_{BET} | Vₜₒₜ | Vₘᵢ | %ₘᵢ | Dₐᵥₑ |
|---|---|---|---|---|---|
| Sample Code | (m²/g) | (cm³/g) | (cm³/g) | (%) | (nm) |
| JDC-500 | 141 | 0.17 | 0.054 | 31.8 | 0.48 |
| JDC-600 | 199 | 0.19 | 0.083 | 43.7 | 0.45 |
| JDC-700 | 334 | 0.29 | 0.18 | 62.1 | 0.34 |

S_{BET} = BET surface area, Vₜₒₜ = total pore volume calculated at P/Pₒ 0.95, Vₘᵢ = HK micropore volume, %ₘᵢ = (Vₘᵢ/Vₜₒₜ) *100, and Dₐᵥₑ = average pore diameter

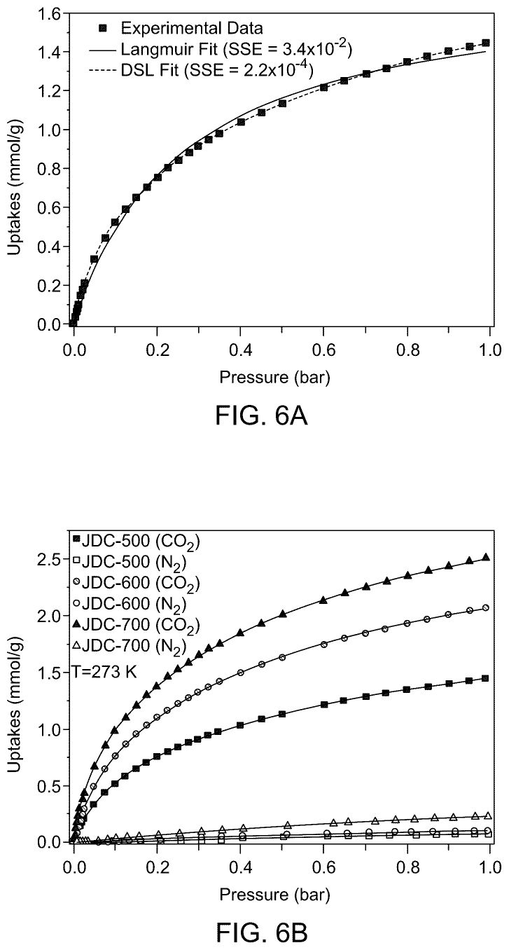

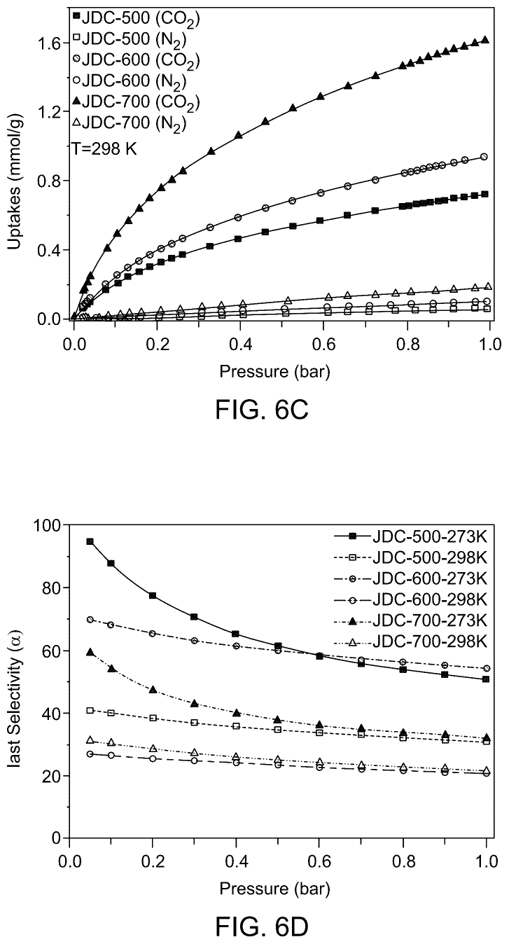

Referring to FIG. 6A, a graph depicting the Langmuir and dual-site Langmuir fitting of JDC-500 isotherm at 0° C. is illustrated. As can be seen from FIG. 5A, the isotherms were fitted with both Langmuir and Dual-Site Langmuir (DSL) models, with the DSL model providing a better fit as indicated by a lower sum squared errors (SSEs) fitness parameter than the Langmuir fit. This suggests the presence of two different types of adsorption sites with varying interactions with the adsorbate molecules. All subsequent isotherms were well-fitted with the DSL model. In order to evaluate the ability of JDCs to adsorb CO₂ and their potential for separating CO₂ and N₂, the isotherms of both gases were measured at temperatures of 0° C. and 25° C. within a pressure range of 0 bar to 1 bar.

Referring to FIGS. 6B-6C, graphs depicting adsorbent isotherms at 0° C. and 25° C., respectively, are illustrated. As can be seen from FIG. 6B, the CO₂ adsorption capacity at 1 bar ranged from 0.7 to 2.5 mmol/g across the measurement temperature (273 K). The trend in CO₂ capacities was observed to be in the following decreasing order: JDC-700>JDC-600>JDC-500, with higher capacities at 0° C. than at 25° C. for each adsorbent. These trends were found to be positively correlated with both BET surface area and pore volumes, which is consistent with previous studies [Sun, M.; Zhu, X.; Wu, C.; Masek, O.; Wang, C.-H.; Shang, J.; Ok, Y. S.; Tsang, D. C., Customizing high-performance molten salt biochar from wood waste for CO2/N2 separation. Fuel Processing Technology, 2022; and Zhu, X.; Sun, M.; Zhu, X.; Guo, W.; Luo, Z.; Cai, W.; Zhu, X., Molten salt shielded pyrolysis of biomass waste: Development of hierarchical biochar, salt recovery, CO₂ adsorption. Fuel, 2023, both of which are incorporated herein by reference in their entireties]. Despite having a lower surface area compared to other reported carbon-based adsorbents, the adsorbents of the present disclosure exhibit good CO₂ uptake. This can be attributed to the tailored narrow micropores with a diameter of less than 1 nm, which facilitate better interaction between CO₂ and the adsorbent. Additionally, the presence of hydroxyl and aromatic functional groups, as confirmed by FTIR analysis (FIG. 3), can enhance CO₂ adsorption capacity through acid-base and π-π interactions.

Referring to FIG. 6D, a graph depicting the adsorbent selectivity for N₂ and CO₂ at 273 K and 298 K is illustrated. FIG. 6D shows the CO₂ over N₂ selectivity at different pressures for a mixture of 15% CO₂ and 85% N₂, which represents post-combustion CO₂ capture. The adsorbents demonstrate a selectivity ranging from 20 to 95, highlighting their potential for CO₂—N₂ separation. At 0° C., all adsorbents exhibit better selectivity than at 25° C. Furthermore, despite its lower adsorption capacity, JDC-500 demonstrates greater CO₂ over N₂ selectivity at pressures less than 0.6 bar compared to JDC-600. At a pressure of 0.6 bar, JDC-500 and JDC-600 exhibit similar selectivities. At a pressure greater than 0.6, JDC-600 exhibits a greater selectivity than JDC-500. JDC-700 exhibits the lowest selectivity of the samples. At a temperature of 25° C., JDC-600 and JDC-700 display nearly identical selectivity levels that are slightly inferior to those of JDC-500.

CO₂—N₂ separation performance indicators of JDCs in the cyclic Vacuum Swing Adsorption (VSA) process are explained herein. In general, VSA is a well-established cyclic process used in various gas separation processes, providing energy-efficient gas separation with automatic control. However, when evaluating adsorbents for lab-scale or pilot plant applications, it may not be practical to use large amounts of adsorbent in VSA. Instead, isotherms can provide an indication of the suitability of an adsorbent for a full-scale VSA process [Sun, M.; Zhu, X.; Wu, C.; Masek, O.; Wang, C.-H.; Shang, J.; Ok, Y. S.; Tsang, D. C., Customizing high-performance molten salt biochar from wood waste for CO₂/N₂ separation. Fuel Processing Technology, 2022, incorporated herein by reference in its entirety].

Table 2 illustrates the working capacity, regenerability, selectivity, and sorbent selection parameter of the adsorbents at different temperatures obtained by utilizing the isotherm results for the calculations. The working capacity reflects the actual usable capacity in the VSA process, and a higher capacity indicates a better performance of the adsorbent. Among the tested adsorbents, JDC-700 exhibited the highest working capacity at both temperatures; however, due to its low CO₂ over N₂ selectivity, JDC-700 may not produce high-purity recovered CO₂. In addition, JDC-500, followed by JDC-600, is expected to perform better in terms of CO₂ recovered purity. Another factor to consider is the adsorbent's regenerability, which refers to its ability to be reused in cyclic experiments. All three materials demonstrate good regenerability, with a range of 60% to 75%.

TABLE 2
CO₂—N₂ separation performance indicators for
a VSA process operation between 1 bar and 0.1 bar.

| | | | | | Sorbent |
|---|---|---|---|---|---|
| | | CO₂ Working | | | Selection |
| Sample | Temperature | Capacity (W) | Selectivity | | Parameter |
| Code | (° C.) | (mmol/g) | α_{CO2/N2} | Regenerability | (S) |
| JDC-500 | 0 | 0.92 | 50.62 | 63 | 449 |
| JDC-600 | 0 | 1.32 | 54.29 | 66 | 658 |
| JDC-700 | 0 | 1.52 | 32.13 | 61 | 148 |
| JDC-500 | 25 | 0.52 | 30.43 | 73 | 238 |
| JDC-600 | 25 | 0.68 | 21.65 | 72 | 117 |
| JDC-700 | 25 | 1.11 | 21.38 | 68 | 119 |

To compare the suitability of different adsorbents for a specific VSA process, a unified parameter called the sorbent selection parameter(S) has been developed. This parameter considers working capacity, selectivity, and regenerability to provide a single empirical value for comparison. Generally, higher S values indicate greater suitability for a particular VSA process under given conditions. Despite its lower working capacity, JDC-600 is the best choice for VSA at 0° C. among these three adsorbents. In addition, for 25° C., JDC-500 outperforms the other two adsorbents, namely JDC-600 and JDC-700.

Aspects of the present disclosure provide a one-step facile carbonization-activation strategy to prepare high-performance adsorbents (carbon nanosheets) for CO₂ adsorption. With the careful choice of activation agent and activation temperature, a narrow micropore size distribution was obtained in the synthesized carbons. The synthesized carbons also showed graphitic motifs, hydroxyl groups, and aromatic rings, which helped to attain a high CO₂ capacity and good CO₂ over N₂ selectivity. The JDC-700 achieved the highest CO₂ adsorption (2.5 mmol/g) and working capacity (1.52 mmol/g) at 0° C. but a lower CO₂/N₂ selectivity (32) than the JDC-600 and the JDC-500, which showed selectivity of 54 and 50, respectively. Taking CO₂ working capacity, regenerability, and selectivity into consideration, sorbent selection parameters were obtained for a VSA process. Based on sorbent selection parameters, JDC-600 is expected to show best CO₂/N₂ separation performance at 0° C., whereas JDC-500 is best suited at 25° C. for CO₂/N₂ separation.

Numerous modifications and variations of the present disclosure are possible in light of the above teachings. It is therefore to be understood that within the scope of the appended claims, the disclosure may be practiced otherwise than as specifically described herein.

1: A method of preparing carbon nanosheets, comprising:
mixing dried and pulverized Corchorus olitorius sticks with an activation agent in a mass ratio range of 1:1 to 1:10 to form a mixture,
wherein the activation agent is a carbonate salt, and
heating the mixture in an inert atmosphere in the range of 500° C. to 700° C. for 2 hours to 8 hours to form the carbon nanosheets,
wherein the heating of the mixture includes ramping at a rate of 10° C./min in a range of 50° C. to 700° C., wherein the carbon nanosheets have an average pore diameter of 0.1 nm to 1.0 nm and a carbon dioxide adsorption capacity of 0.5 mmol/g to 3.5 mmol/g,
wherein the carbon nanosheets form a porous foam with perforated carbon nanosheet cell walls.

2: The method of claim 1, wherein the perforated carbon nanosheets have an average pore diameter of 0.3 nm to 0.5 nm.

3: The method of claim 1, wherein the perforated carbon nanosheet cell walls have interconnected networks of open cells.

4: The method of claim 1, wherein the perforated carbon nanosheets have a D-band to G-band ratio of 0.5 is to 0.9.

5: The method of claim 1, wherein the perforated carbon nanosheets have a Brunauer-Emmett-Teller (BET) surface area of 100 m²/g to 400 m²/g.

6: The method of claim 1, wherein the perforated carbon nanosheets have a total pore volume of 0.150 cm³/g to 0.350 cm³/g.

7: The method of claim 1, wherein the perforated carbon nanosheets have a Horvath-Kawazoe micropore volume of 0.030 cm³/g to 0.200 cm³/g.

8: The method of claim 1, wherein 30% to 65% of pores in the perforated carbon nanosheets are micropores based on the total pore volume.

9: The method of claim 1, wherein the perforated carbon nanosheets have a carbon dioxide adsorption capacity of 1 mmol/g to 3 mmol/g at a temperature of 0° C. and at a pressure of 1 bar.

10: The method of claim 1, wherein the perforated carbon nanosheets have a carbon dioxide adsorption capacity of 0.6 mmol/g to 1.7 mmol/g at a temperature of 25° C. and at a pressure of 1 bar.

11: The method of claim 1, wherein the perforated carbon nanosheets have a carbon dioxide working capacity of 0.8 mmol/g to 1.6 mmol/g at a temperature of 0° C.

12: The method of claim 1, wherein the mass ratio of Corchorus olitorius to activation agent is 1:4, the heating temperature is 700° C., the heating time is 5 hours, and the perforated carbon nanosheets have a carbon dioxide adsorption capacity of 2.4 mmol/g to 2.6 mmol/g and a carbon dioxide working capacity of 1.45 mmol/g to 1.60 mmol/g at a temperature of 0° C.

13: The method of claim 1, wherein the perforated carbon nanosheets have a selectivity of 28 to 58 based on a fraction of carbon dioxide adsorption capacity over nitrogen adsorption capacity multiplied by a fraction of nitrogen partial pressure over carbon dioxide partial pressure at a temperature of 0° C.

14: The method of claim 1, wherein the mass ratio of Corchorus olitorius to activation agent is 1:4, the heating temperature is 600° C., the heating time is 5 hours, and the perforated carbon nanosheets have a selectivity of 53 to 55 based on a fraction of carbon dioxide adsorption capacity over nitrogen adsorption capacity multiplied by a fraction of nitrogen partial pressure over carbon dioxide partial pressure at a temperature of 0° C.

15: The method of claim 1, wherein the perforated carbon nanosheets have a regenerability of 58% to 70% based on the carbon dioxide working capacity and carbon dioxide adsorption capacity at a temperature of 0° C.

16: The method of claim 1, wherein the perforated carbon nanosheets have a regenerability of 65% to 75% based on the carbon dioxide working capacity and carbon dioxide adsorption capacity at a temperature of 25° C.

17: The method of claim 1, wherein the perforated carbon nanosheets have a sorbent selection parameter of 120 to 670 based on a fraction the carbon dioxide adsorption capacity divided by the nitrogen adsorption capacity squared over the carbon dioxide desorption capacity divided by the nitrogen desorption capacity multiplied by a fraction of the carbon dioxide working capacity over the nitrogen working capacity at a temperature of 0° C.

18: The method of claim 1, wherein the mass ratio of Corchorus olitorius to activation agent is 1:4, the heating temperature is 600° C., the heating time is 5 hours, and the perforated carbon nanosheets have a sorbent selection parameter of 655 to 660 based on a fraction the carbon dioxide adsorption capacity divided by the nitrogen adsorption capacity squared over the carbon dioxide desorption capacity divided by the nitrogen desorption capacity multiplied by a fraction of the carbon dioxide working capacity over the nitrogen working capacity at a temperature of 0° C.

19: The method of claim 1, wherein the mass ratio of Corchorus olitorius to activation agent is 1:4, the heating temperature is 500° C., the heating time is 5 hours, and the perforated carbon nanosheets have a sorbent selection parameter of 235 to 240 based on a fraction the carbon dioxide adsorption capacity divided by the nitrogen adsorption capacity squared over the carbon dioxide desorption capacity divided by the nitrogen desorption capacity multiplied by a fraction of the carbon dioxide working capacity over the nitrogen working capacity at a temperature of 25° C.

20: The method of claim 1, wherein the carbonate salt is sodium bicarbonate.
